(19) United States
(12) Patent Application Publication
(10) Pub. No.: US 2026/0156234 A1
(43) Pub. Date: Jun. 4, 2026

(54) ELECTRONIC APPARATUS AND CONTROLLING METHOD THEREOF

(71) Applicant: Samsung Electronics Co., Ltd., Suwon-si (KR)

(72) Inventor: Hyungjun LIM, Suwon-si (KR)

(21) Appl. No.: 19/391,449

(22) Filed: Nov. 17, 2025

Related U.S. Application Data
(63) Continuation of application No. PCT/KR2025/014277, filed on Sep. 12, 2025.

(30) Foreign Application Priority Data
Dec. 2, 2024 (KR) 10-2024-0176824

(51) Int. Cl. H04N 9/31

(52) U.S. Cl. CPC H04N 9/3173; H04N 9/3185; H04N 9/3188

(57) ABSTRACT

An electronic apparatus includes: a sensor, a driver comprising circuitry, memory storing instructions, and at least one processor, comprising processing circuitry, individually and/or collectively, configured to execute the instructions, and to cause the electronic apparatus to: based on an event corresponding to an image projection occurring, identify a projection surface corresponding to the image projection, and control the driver to move to a projection position obtained based on a projection distance to the projection surface, a projection angle corresponding to the image projection to the projection surface, and a movement distance.

### CROSS-REFERENCE TO RELATED APPLICATIONS

This application is a continuation of International Application No. PCT/KR2025/014277 designating the United States, filed on Sep. 12, 2025, in the Korean Intellectual Property Receiving Office and claiming priority to Korean Patent Application No. 10-2024-0176824, filed on Dec. 2, 2024, in the Korean Intellectual Property Office, the disclosures of each of which are incorporated by reference herein in their entireties.

### BACKGROUND

### Field

The disclosure relates to an electronic apparatus and a controlling method thereof, and for example, to an electronic apparatus capable of identifying an optimal/improved projection position and projecting an image on the identified projection position, and a controlling method thereof.

### Description of Related Art

With the recent development of electronic technology and optical technology, various projectors have been utilized. A projector refers to an electronic apparatus that projects light onto a projection surface (or a screen) so that an image is formed on the projection surface. In addition, mobile electronic apparatuses (e.g., robots, etc.) including projectors have recently been developed. Mobile electronic apparatuses provide various information to users using projectors while moving through specific spaces (e.g., home, restaurants, airports, etc.)

Fixed electronic apparatuses of the related art include a keystone correction function of correcting a screen according to a projection direction to show users the straight screen. However, when there is an obstacle within a range for an electronic apparatus to project toward the projection surface and viewing is interfered, there is the inconvenience for a user to directly adjust the position and direction of the electronic apparatus to find an optimal projection surface without the obstacle.

Recently, mobile electronic apparatuses have been developed to address this problem. A mobile electronic apparatus includes a function of moving a main body or changing a projection angle, thereby changing a projection surface or a projection position of an electronic apparatus. Therefore, a method of identifying an optimal/improved projection position using a mobile electronic apparatus is required.

### SUMMARY

According to an example embodiment of the present disclosure, an electronic apparatus includes: a sensor, a driver, including circuitry, memory storing instructions, and at least one processor, comprising processing circuitry, wherein at least one processor collectively or individually, is configured to execute the instructions and to cause the electronic apparatus to: based on an event corresponding to an image projection, identify a projection surface corresponding to the image projection, and control the driver to move to a projection position obtained based on a projection distance to the projection surface, a projection angle corresponding to the image projection to the projection surface, and a movement distance.

At least one processor collectively or individually, may be configured to cause the electronic apparatus to obtain a score corresponding to each of a plurality of candidate positions based on the projection distance, the projection angle, and the movement distance with respect to each of the plurality of candidate positions obtained based on a current position, and obtain a projection position based on the obtained score.

At least one processor collectively or individually, may be configured to cause the electronic apparatus to, based on a projection distance from a candidate position to the projection surface being within a first range, obtain a first score which is a highest point as a score corresponding to the projection distance, and based on the projection distance from the candidate position to the projection surface being farther than the first range, obtain a score corresponding to the projection distance lower than the first score.

At least one processor collectively or individually, may be configured to cause the electronic apparatus to, based on a projection angle corresponding to an image projection to the projection surface from a candidate position being less than a first value, obtain a second score which is a highest point as a score corresponding to the projection angle, and based on the projection angle corresponding to the image projection to the projection surface from the candidate position being greater than the first value, obtain a score corresponding to the projection angle lower than the second score.

At least one processor collectively or individually, may be configured to cause the electronic apparatus to, based on a movement distance to a candidate position being less than a second value, obtain a third score which is a highest point as a score corresponding to the movement distance, and based on the movement distance to the candidate position being greater than the second value, obtain a score with respect to the movement distance lower than the third score.

At least one processor collectively or individually, may be configured to cause the electronic apparatus to, based on an obstacle existing near the projection surface, obtain a projection angle for projecting the image onto the projection surface by avoiding the obstacle based on a current projection angle, an angle of view, a size of the obstacle, and a projection distance to the projection surface.

At least one processor collectively or individually, may be configured to cause the electronic apparatus to, based on an obstacle existing near the projection surface, obtain a movement distance for projecting the image in front of the projection surface by avoiding the obstacle based on a current projection angle, the angle of view, a size of the obstacle, and a projection distance to the projection surface.

At least one processor collectively or individually, may cause the electronic apparatus to, after moving to the optimal projection position, identify whether an obstacle exists within a range for projecting an image onto the projection surface around the optimal projection

At least one processor collectively or individually, may be configured to cause the electronic apparatus to, based on no obstacles existing within the range, control the image to be projected onto the projection surface at the optimal projection position, and based on the obstacle existing within the range, obtain one of a plurality of candidate positions around the optimal projection position based on the projection distance, the projection angle, and the movement distance.

The electronic apparatus may further include a projector, and at least one processor collectively or individually, may be configured to cause the electronic apparatus to, after moving to the projection position, project an image through the projector.

According to an example embodiment of the present disclosure, a method of controlling an electronic apparatus includes: based on an event corresponding to an image projection, identifying a projection surface corresponding to the image projection, and moving to a projection position obtained based on a projection distance to the projection surface, a position. projection angle corresponding to the image projection to the projection surface, and a movement distance.

The moving may include obtaining a score corresponding to each of a plurality of candidate positions based on the projection distance, the projection angle, and the movement distance with respect to each of the plurality of candidate positions obtained based on a current position, and obtaining the projection position based on the obtained score.

The obtaining of the score may include, based on a projection distance from a candidate position to the projection surface being within a first range, obtaining a first score which is a highest point as a score corresponding to the projection distance, and based on the projection distance from the candidate position to the projection surface being farther than the first range, obtaining a score corresponding to the projection distance lower than the first score.

The obtaining of the score may include, based on a projection angle corresponding to an image projection to the projection surface from a candidate position being less than a first value, obtaining a second score which is a highest point as a score corresponding to the projection angle, and based on the projection angle corresponding to the image projection to the projection surface from the candidate position being greater than the first value, obtaining a score corresponding to the projection angle lower than the second score.

The obtaining of the score may include, based on a movement distance to a candidate position being less than a second value, obtaining a third score which is a highest point as a score corresponding to the movement distance, and based on the movement distance to the candidate position being greater than the second value, obtaining a score with respect to the movement distance lower than the third score.

The moving may include, based on an obstacle existing near the projection surface, obtaining a projection angle for projecting the image onto the projection surface by avoiding the obstacle based on a current projection angle, an angle of view, a size of the obstacle, and a projection distance to the projection surface.

The moving may include, based on an obstacle existing near the projection surface, obtaining a movement distance for projecting the image in front of the projection surface by avoiding the obstacle based on a current projection angle, the angle of view, a size of the obstacle, and a projection distance to the projection surface.

The method may include, after moving to the optimal projection position, identifying whether an obstacle exists within a range for projecting an image onto the projection surface around the projection position.

The method may include, based on no obstacles existing within the range, projecting the image onto the projection surface at the optimal projection position, and based on the obstacle existing within the range, obtaining one of a plurality of candidate positions around the projection position based on the projection distance, the projection angle, and the movement distance.

According to an example embodiment of the present disclosure, a non-transitory computer-readable medium storing instructions which when executed by at least one processor, comprising processing circuitry, individually and/or collectively, of an electronic device, cause the electronic device to perform a method of controlling the electronic device, wherein the method includes: based on an event corresponding to an image projection, identifying a projection surface corresponding to the image projection, and moving to a projection position obtained based on a projection distance to the projection surface, a projection angle corresponding to the image projection to the projection surface, and a movement distance.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example electronic apparatus for projecting an image at an optimal projection position according to various embodiments;

FIG. 2 is a block diagram illustrating an example configuration of an electronic apparatus according to various embodiments;

FIGS. 3A and 3B are perspective views illustrating an external appearance of an electronic apparatus according to various embodiments;

FIGS. 4A, 4B and 4C are diagrams illustrating an example method of rotating an electronic apparatus to adjust a projection angle of the electronic apparatus according to various embodiments;

FIG. 5 is a diagram illustrating an example method of moving an electronic apparatus to adjust a projection position of the electronic apparatus according to various embodiments;

FIG. 6 is a flowchart illustrating an example operation in which an electronic apparatus projects an image by identifying an optimal projection position according to various embodiments;

FIG. 7A is a diagram illustrating example characteristics of an image projected onto a projection surface according to a projection distance, according to various embodiments;

FIG. 7B is a diagram illustrating example characteristics of an image projected onto a projection surface according to a projection angle, according to various embodiments;

FIG. 8 includes graphs illustrating scores with respect to a projection distance, a projection angle, and a movement distance according to various embodiments;

FIG. 9 is a diagram illustrating an example method of identifying an optimal projection position according to a projection distance, a projection angle, and a movement distance according to various embodiments;

FIGS. 10, 11 and 12 are diagrams illustrating an example in which a projection angle is adjusted to avoid an obstacle, according to various embodiments;

FIG. 13 is a diagram illustrating an example in which an electronic apparatus moves to avoid an obstacle, according to various embodiments;

FIG. 14 is a diagram for illustrating an example in which a projection angle and a movement distance of an electronic apparatus are adjusted when a movement distance is limited due to an obstacle, according to various embodiments;

FIG. 15 is a diagram illustrating example image projection results according to conventional methods and various embodiments; and

FIG. 16 is a flowchart illustrating an example operation in which an image is projected by identifying an optimal projection position according to various embodiments.

### DETAILED DESCRIPTION

The various example embodiments may apply various conversions, and thus example embodiments will be shown in the drawings and described in greater detail in the detailed description. However, this is not intended to limit the scope of the disclosure and should be understood to include various modifications, equivalents, and/or alternatives of the disclosure. With respect to the description of the drawings, similar reference numerals may be used for similar components.

In describing the present disclosure, when it is determined that a detailed description of a related known function or configuration may unnecessarily obscure the gist of the present disclosure, a detailed description thereof may be omitted.

The following example embodiments may be modified into various different forms, and the scope of the present disclosure is not limited to the following embodiments.

The terms used in the present disclosure are used to describe various embodiments and are not intended to limit the scope of the disclosure. A term of a singular number may include its plural number unless explicitly indicated otherwise in the context.

In the present disclosure, expressions such as “have,” “may have,” “include,” “may include,” etc. may indicate the existence of a corresponding feature (e.g., a numerical value, a function, an operation or a component such as parts), and does not exclude the existence of an additional feature.

In the present disclosure, the expressions such as “A or B,” “at least one of A and/or B,” or “at least one or more of A and/or B” may include all available combinations of items listed together. For example, the expressions such as “A or B,” “at least one of A and B,” or “at least one of A or B” may signify all cases of including (1) at least one A, including (2) at least one B, or including (3) both of at least one A and at least one B.

In the present disclosure, expressions “first,” “second,” etc., used herein may qualify various components regardless of a sequence or importance of the components. These expressions are used to distinguish one component from another component, and do not limit the corresponding components.

When any component (e.g., a first component) is described as “(operatively or communicatively) coupled with/to” or “connected to another component (e.g., a second component)”, it is to be understood that the component may be directly coupled to the other component or may be coupled to the other component through still another component (e.g., a third component).

When any component (e.g., a first component) is described as “directly connected” or “directly connected” to another component (e.g., a second component), it may be understood that no other component (e.g., a third component) exists between the component and the other component.

As used herein, the expression “configured to” may be interchangeably used with, for example, “suitable for”, “having the capacity to”, “designed to”, “adapted to”, “made to”, or “capable of”, according to a situation. The expression “configured to” may not imply only “specially designed to” in a hardware manner.

In a certain circumstance, the expression “an apparatus configured to” may indicate the apparatus “capable of” together with another apparatus or components. For example, “a processor configured (or set) to perform A, B, and C” may imply a dedicated processor (e.g., an embedded processor) for performing a corresponding operation or a generic-purpose processor (e.g., central processing unit (CPU) or an application processor) capable of performing corresponding operations by executing one or more software programs stored in memory.

In an embodiment, a “module” or a component with a name ending in “˜er/˜or” may perform at least one function or operation, may be implemented by hardware or software, or be implemented by a combination of hardware and software. In addition, a plurality of “modules” or a plurality of components with names ending in “˜ers/˜ors” may be integrated in at least one module to be implemented by at least one processor except for a “module” or a component with a name ending in “˜er/or” which needs to be implemented by a specific hardware.

In an embodiment, a “state” may be replaced with a term such as “situation”, “mode”, etc. For example, a “wall projection state” may be replaced with a “wall projection situation”, a “wall projection mode”, etc.

On the other hand, various elements and areas in the drawings are schematically drawn. Therefore, the present disclosure is not limited by the relative sizes or spaces drawn in the accompanying drawings.

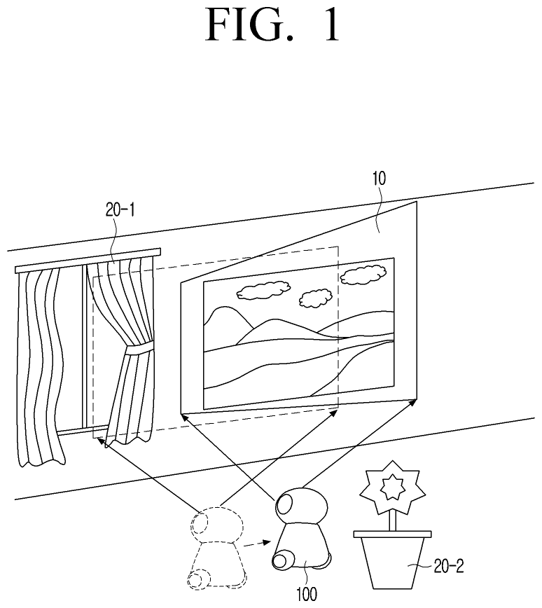

FIG. 1 is a diagram illustrating an example electronic apparatus for projecting an image at an optimal projection position according to various embodiments. As shown in FIG. 1, an electronic apparatus 100 according to an embodiment of the present disclosure may be implemented as a portable projector, but this an example, and may be implemented as various mobile electronic apparatuses such as a robot.

For example, according to an embodiment of the present disclosure, the electronic apparatus 100 may include a projector for projecting an image. At this time, the projector is a device that projects an image onto a screen, wall, or floor through light. The projector may process an input image signal and enlarge and project the processed image signal through a light source and a lens system.

For example, the projector may include a long throw projection lens and an ultra-short throw projection lens. The projector may project an image to a wall or a position far from a screen installed on the wall using the long throw projection lens. In addition, the projector may project an image close to the wall or the floor using an ultra-short throw projection lens.

According to an embodiment of the present disclosure, the electronic apparatus 100 may project an image on an optimal projection position by identifying the optimal projection position. For example, the electronic apparatus 100 may identify an image projection surface 10 (or referred to as a “projection surface”) based on a first obstacle 20-1 and a second obstacle 20-2, and identify the optimal projection position for projecting an image onto the identified projection surface 10. The electronic apparatus 100 may identify an optimal projection position of the electronic apparatus 100 based on a projection distance (or “a projection distance to the projection surface”) between the image projection surface 10 and the electronic apparatus 100, a projection angle (or “a projection angle corresponding to an image projection on the projection surface”) at which the electronic apparatus 100 projects the image onto the image projection surface 10, and a movement distance of the electronic apparatus 100. For example, the electronic apparatus 100 may identify a plurality of candidate positions with respect to the current position of the electronic apparatus 100. In addition, the electronic apparatus 100 may identify scores with respect to plurality of candidate positions based on a projection distance, a projection angle, and a movement distance of each of the identified plurality of candidate positions. The electronic apparatus 100 may identify a candidate position having the highest identified score as the optimal projection position.

In addition, the electronic apparatus 100 may project an image toward the image projection surface 10 by moving the optimal projection position. Here, based on the projection angle being greater than or equal to a threshold angle at the optimal projection position, the electronic apparatus 100 performs keystone correction on the image so that the image may appear straight and projects the image on which the keystone correction has been performed.

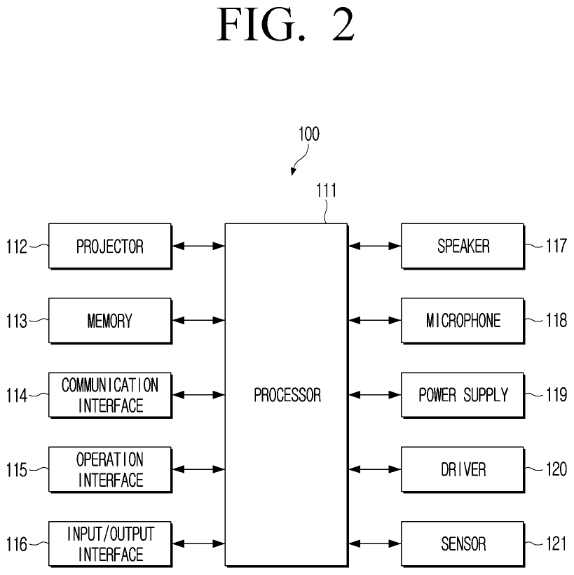

FIG. 2 is a block diagram illustrating an example configuration of the electronic apparatus 100 according to various embodiments. Referring to FIG. 2, the electronic apparatus 100 may include at least one of a processor (e.g., including processing circuitry) 111, a projector 112, memory 113, a communication interface (e.g., including communication circuitry) 114, an operation interface 115, an input/output interface (e.g., including circuitry) 116, a speaker 117, a microphone 118, a power supply 119, a driver 120, and/or a sensor 121. The components shown in FIG. 2 are merely various embodiments, and some components may be omitted, and new components may be added.

The projector 112 may refer to a component to project an image to the outside. According to various embodiments of the present disclosure, the projector 112 may be implemented in various projection methods (e.g., a cathode-ray tube (CRT) method, a liquid crystal display (LCD) method, a digital light processing (DLP) method, a laser method, etc.) For example, the principle of the CRT method is basically the same as that of a CRT monitor. The CRT method enlarges an image with a lens in front of a CRT and displays the image on a screen. The CRT method is divided into a one-tube type and a three-tube type according to the number of CRTs, and the three-tube type may be separately implemented as cathode-ray tubes for red, green, and blue colors.

As another example, the LCD method may refer to a method of displaying an image by transmitting light from a light source through a liquid crystal. The LCD method is divided into a single-plate type and a three-plate type, and the three-plate type separates light from a light source into red, green, and blue light on a dichroic mirror (a mirror that reflects only a specific color of light and passes the remaining colors therethrough), and gathers the light again after transmitting through a liquid crystal.

As another example, the DLP method may refer to a method of displaying an image using a digital micromirror device (DMD) chip. A DLP type projector may include a light source, a color wheel, a DMD chip, a projection lens, etc. Light output from the light source may be colored while passing through a rotating color wheel. The light passing through the color wheel is input to the DMD chip. The DMD chip includes numerous fine mirrors and reflects the light input to the DMD chip. The projection lens may serve to enlarge the light reflected from the DMD chip to an image size.

As another example, the laser method includes a diode pumped solid state (DPSS) laser and a galvanometer. A laser that outputs various colors uses a laser that overlaps optical axes using a special mirror after installing three DPSS lasers for each RGB color. The galvanometer includes a mirror and a high-power motor to move the mirror at high speed. For example, the galvanometer may rotate the mirror at up to 40 kHz/sec. The galvanometer is mounted according to a scan direction, and in general, the projector performs a planar scan, so that the galvanometer may be divided into x and y axes.

The projector 112 may include various types of light sources. For example, the projector 112 may include a light source of at least one of a lamp, an LED, or a laser.

The projector 112 may output an image at a 4:3 screen ratio, a 5:4 screen ratio, or a 16:9 wide screen ratio according to the purpose of the electronic apparatus 100 or the setting of a user, and may output an image at various resolutions such as WVGA (854*480), SVGA (800*600), XGA (1024*768), WXGA (1280*720), WXGA (1280*800), SXGA (1280*1024), UXGA (1600*1200), full HD (1920*1080), etc. according to the screen ratio.

The projector 112 may perform various functions for adjusting the output image by the control of the processor 111. For example, the projector 112 may perform functions such as zoom, keystone, quick corner (4 corners), keystone, lens shift, etc.

For example, the projector 112 may enlarge or reduce an image according to a distance (projection distance) from the screen. For example, the zoom function may be performed according to the distance from the screen. In this regard, the zoom function may include a hardware method of adjusting the size of the screen by moving a lens and a software method of adjusting the size of the screen such as cropping an image. On the other hand, when the zoom function is performed, it is necessary to adjust the focus of the image. For example, a method of adjusting the focus includes a manual focus method, an electric focus method, etc. The manual focus method may refer, for example, to a method of manually focusing, and the electric focus method may refer, for example, to a method of automatically focusing using a motor with an embedded projector when the zoom function is performed. When performing the zoom function, the projector 112 may provide a digital zoom function through software, and may provide an optical zoom function of performing the zoom function by moving the lens through a rotator.

The projector 112 may perform a keystone correction function. When the height does not fit on a front projection, the screen may be distorted up or down. The keystone correction function refers to a function of correcting a distorted screen. For example, when distortion occurs in the left and right directions of the screen, the distortion may be corrected using a horizontal keystone, and when distortion occurs in the up and down direction, the distortion may be corrected using a vertical keystone. The quick corner (4 corners) keystone correction function corrects the screen when the center area of the screen is normal, but the corner areas are not balanced. The lens shift function is a function of shifting the screen as it is when the screen is off the screen.

The projector 112 may provide the zoom/keystone/focus function by automatically analyzing a surrounding environment and a projection environment without a user input. For example, the projector 112 may automatically provide the zoom/keystone/focus functions based on a distance between the electronic apparatus 100 and the screen, information about a space where the electronic apparatus 100 is currently located, and information about an amount of ambient light, etc. detected through a sensor (a depth camera, a distance sensor, an infrared sensor, an illumination sensor, etc.)

The projector 112 may provide a lighting function using a light source. In particular, the projector 112 may provide the lighting function by outputting the light source using an LED. According to various embodiments, the projector 112 may include one LED, and according to an embodiment, the electronic apparatus 100 may include a plurality of LEDs. The projector 112 may output a light source using a surface emitting LED according to an implementation example. Here, the surface emitting LED may refer to an LED having a structure in which an optical sheet is disposed on an upper side of the LED so that the light source is evenly distributed and output. Specifically, when the light source is output through the LED, the light source may be evenly distributed through the optical sheet, and the light source distributed through the optical sheet may be incident on a display panel.

The projector 112 may provide a dimming function for adjusting the intensity of the light source to a user. For example, when an input (e.g., a user input) for adjusting the intensity of the light source is received from the user through the operation interface 115 (e.g., a touch display button or dial), the projector 112 may control the LED to output the intensity of the light source corresponding to the received user input.

The projector 112 may provide a dimming function based on content analyzed by the processor 111 without a user input. For example, the projector 112 may control the LED to output the intensity of the light source based on information about the currently provided content (e.g., content type, content brightness, etc.)

The projector 112 may control a color temperature by the control of the processor 111. The processor 111 may include various processing circuitry and control the color temperature based on content. For example, when the content is identified to be output, the processor 111 may obtain color information for each frame of the content of which output is determined. The processor 111 may control the color temperature based on the obtained color information for each frame. Here, the processor 111 may obtain at least one or more primary colors of the frame based on the color information for each frame. The processor 111 may adjust the color temperature based on the obtained at least one or more primary colors. For example, the color temperature that may be controlled by the processor 111 may be classified into a warm type or a cold type. It is assumed that a frame to be output (hereinafter, referred to as an output frame) includes a scene where a fire occurs. The processor 111 may identify (or obtain) that the primary color is red based on the color information included in the current output frame. In addition, the processor 111 may identify a color temperature corresponding to the identified primary color (red). Here, the color temperature corresponding to red may be the warm type. The processor 111 may use an artificial intelligence model to obtain the color information or the primary color of the frame. According to various embodiments, the artificial intelligence model may be stored in the electronic apparatus 100 (e.g., the memory 113). According to an embodiment, the artificial intelligence model may be stored in an external server capable of communicating with the electronic apparatus 100.

The projector 112 may include a long throw projection lens and an ultra-short throw projection lens. The long throw projection lens, which is a lens capable of projecting a large screen from a long distance, may project an image from a position several meters to several tens of meters away. The ultra-short focus projection lens, which is a lens capable of projecting a large screen from a very short distance, may project an image from a position several tens of centimeters away.

The projector 112 may further include a switcher comprising circuitry capable of switching (or changing or tilting) the long throw projection lens and the ultra-short throw projection lens. That is, the projector 112 may switch between the long throw projection lens and the ultra-short throw projection lens using the switcher by the control of the processor 111.

The memory 113 may be implemented as an internal memory such as ROM (e.g., an electrically erasable programmable read-only memory (EEPROM)), RAM, etc. included in the processor 111, or may be implemented as memory separate from the processor 111. In this case, the memory 113 may be implemented in the form of memory embedded in the electronic apparatus 100 or may be implemented in the form of memory detachable from the electronic apparatus 100 according to the purpose of data storage. For example, data for driving the electronic apparatus 100 may be stored in the memory embedded in the electronic apparatus 100, and data for an extended function of the electronic apparatus 100 may be stored in the memory detachable from the electronic apparatus 100.

The memory embedded in the electronic apparatus 100 may be implemented as at least one of a volatile memory (e.g., dynamic RAM (DRAM), static RAM (SRAM), or synchronous dynamic RAM (SDRAM)), a non-volatile memory (e.g., one time programmable ROM (OTPROM), programmable ROM (PROM), erasable and programmable ROM (EPROM), EEPROM, a mask ROM, a flash ROM, a flash memory (e.g., NAND flash or NOR flash), a hard drive, or a solid state drive (SSD), and the memory detachable from the electronic apparatus 100 may be implemented as at least one of memory card (e.g., compact flash (CF), secure digital (SD), micro secure digital (Micro-SD), mini secure digital (Mini-SD), extreme digital (xD), a multi-media card (MMC), etc.), or an external memory (e.g., USB memory) that may be connectable to a USB port, etc.

The memory 113 may store one or more instructions related to the electronic apparatus 100. In addition, an operating system (O/S) for driving the electronic apparatus 100 may be stored in the memory 113. In addition, various software programs or applications for operating the electronic apparatus 100 may be stored in the memory 113 according to various embodiments of the present disclosure. In addition, the memory 113 may include a semiconductor memory such as a flash memory or a magnetic storage medium such as a hard disk.

For example, various software modules for operating the electronic apparatus 100 may be stored in the memory 113 according to various embodiments of the present disclosure, and the processor 111 may control the operation of the electronic apparatus 100 by executing various software modules stored in the memory 113. That is, the memory 113 may be accessed by the processor 111, and reading/writing/correction/deletion/updating of data by the processor 111 may be performed.

For example, the memory 113 may store information about a map in the house where the electronic apparatus 100 is located. In this regard, the map may include a picture showing a planar structure in the house with a promised symbol by reducing the planar structure at a certain ratio. For example, the map may include the picture of the planar structure in the house with lines. However, the present disclosure is not limited thereto, and the map may include positions of main objects inside the house.

The map according to an embodiment of the present disclosure may be a 2D map, but this is only an embodiment, and may be a 3D map.

In the present disclosure, the term the memory 113 may be used to include a storage, a ROM (not shown) or a RAM (not shown) in the processor 111, or memory card (not shown) (e.g., a micro SD card, memory stick) mounted on the electronic apparatus 100.

The communication interface 114 is a component including various communication circuitry configured to perform communication with various types of external devices according to various types of communication methods. The communication interface 114 may include a wireless communication module or a wired communication module. Here, each communication module may be implemented in the form of at least one hardware chip.

The wireless communication module may be a module that wirelessly communicates with an external device. For example, the wireless communication module may include at least one of a Wi-Fi module, a Bluetooth module, an infrared communication module, or other communication modules.

The Wi-Fi module and the Bluetooth module may perform communication using a Wi-Fi method and a Bluetooth method, respectively. When using the Wi-Fi module or the Bluetooth module, the communication interface 114 may first transmit and receive various connection information such as a service set identifier (SSID) and a session key, perform communication connection using the connection information, and then transmit and receive various information.

The infrared communication module may include various circuitry and performs communication according to infrared data association (IrDA) technology that wirelessly transmits data at a short distance using infrared rays between visible light and millimeter waves.

The other communication modules may include at least one communication chip that performs communication according to various wireless communication standards such as ZigBee, 3rd generation (3G), a 3rd generation partnership project (3GPP), long term evolution (LTE), LTE advanced (LTE-A), 4th generation (4G), 5th generation (5G), in addition to the above-described communication methods.

The wired communication module may be a module that communicates with an external device by wired. For example, the wired communication module may include at least one of a local area network (LAN) module, an Ethernet module, a pair cable, a coaxial cable, an optical fiber cable, or an ultra wide-band (UWB) module.

The communication interface 114 may communicate with an external device 200. The communication interface 114 may receive information about the external device 200 (e.g., information about the current position of the external device 200, information about a device provided in the external device 200, etc.) from the external device 200. The communication interface 114 may transmit path information to the external device 200 and transmit information about a multi-projector system.

The operation interface 115 may include various types of input devices. For example, the operation interface 115 may include physical buttons. In this case, the physical buttons may include a function key, a direction key (e.g., a four-way key), or a dial button. According to various embodiments, the physical buttons may be implemented as a plurality of keys. According to an embodiment, the physical buttons may be implemented as one key. When the physical buttons are implemented as one key, the electronic apparatus 100 may receive a user input in which one key is pressed for a threshold time or more. When the user input in which one key is pressed for the threshold time or more is received, the processor 111 may perform a function corresponding to the user input. For example, the processor 111 may provide a lighting function based on the user input.

The operation interface 115 may receive a user input using a non-contact method. When a user input is received through a contact method, a physical force needs to be transmitted to the electronic apparatus 100. Therefore, a method for controlling the electronic apparatus 100 regardless of physical force may be required. Specifically, the operation interface 115 may receive a user gesture and perform an operation corresponding to the received user gesture. Here, the operation interface 115 may receive a user's gesture through a sensor (e.g., an image sensor or an infrared sensor).

The operation interface 115 may receive a user input using a touch method. For example, the operation interface 115 may receive the user input through a touch sensor. According to various embodiments, the touch method may be implemented in a non-contact manner. For example, the touch sensor may determine whether the user's body has approached within a threshold distance. Here, the touch sensor may identify a user input even when the user does not contact the touch sensor. Meanwhile, according to another implementation example, the touch sensor may identify a user input that the user touches the touch sensor.

The electronic apparatus 100 may receive an input in various methods in addition to the above-described operation interface 115. In various embodiments, the electronic apparatus 100 may receive a user input through an external remote controller. Here, the external remote controller may be a remote controller corresponding to the electronic apparatus 100 (e.g., a dedicated control device of the electronic apparatus 100) or a portable communication device of the user (e.g., a smartphone or a wearable device). Here, an application for controlling the electronic apparatus 100 may be stored in the portable communication device of the user.

The portable communication device may obtain a user input through the stored application and transmit the obtained user input to the electronic apparatus 100. The electronic apparatus 100 may receive a user input from the portable communication device and perform an operation corresponding to a control command of the user.

The electronic apparatus 100 may receive a user input using voice recognition. According to various embodiments, the electronic apparatus 100 may receive a user voice through a microphone included in the electronic apparatus 100. According to an embodiment, the electronic apparatus 100 may receive a user voice from a microphone or an external device. For example, the external device may obtain a user voice through a microphone of the external device, and transmit the obtained user voice to the electronic apparatus 100. The user voice transmitted from the external device may be audio data or digital data in which the audio data is converted (e.g., audio data converted into a frequency domain, etc.) The electronic apparatus 100 may perform an operation corresponding to the received user voice. For example, the electronic apparatus 100 may receive audio data corresponding to the user voice through the microphone. In addition, the electronic apparatus 100 may convert the received audio data into digital data. In addition, the electronic apparatus 100 may convert the converted digital data into text data using a speech to text (STT) function. According to various embodiments, the STT function may be performed directly in the electronic apparatus 100, and according to an embodiment, the STT function may be performed in an external server. The electronic apparatus 100 may transmit the digital data to the external server. The external server may convert digital data into text data and obtain control command data based on the converted text data. The external server may transmit the control command data (in this regard, text data may also be included) to the electronic apparatus 100. The electronic apparatus 100 may perform an operation corresponding to the user voice based on the obtained control command data.

The electronic apparatus 100 may provide a voice recognition function using one assistance (or an artificial intelligence secretary, such as Bixby™, etc.), but this is only various embodiments, and the electronic apparatus 100 may provide the voice recognition function through a plurality of assistances. In this regard, the electronic apparatus 100 may provide the voice recognition function by selecting one of the plurality of assistances based on a trigger word corresponding to the assistance or a specific key present in a remote controller.

The electronic apparatus 100 may receive a user input using a screen interaction. The screen interaction may refer, for example, to a function of identifying whether a predetermined (e.g., specified) event occurs through an image projected onto the screen (or projection surface) by the electronic apparatus 100 and obtaining a user input based on the predetermined event. The predetermined event may refer, for example, to an event in which a predetermined object is identified at a specific position (e.g., a position on which a UI for receiving a user input is projected). The predetermined object may include at least one of a part (e.g., a finger) of the user's body, an indicator rod, or a laser point. Based on the predetermined object being identified at the position corresponding to the projected UI, the electronic apparatus 100 may identify that a user input for selecting the projected UI has been received. For example, the electronic apparatus 100 may project a guide image to display a UI on the screen. In addition, the electronic apparatus 100 may identify whether the user selects the projected UI. For example, based on the predetermined event being identified at the position of the projected UI, the electronic apparatus 100 may identify that the user has selected the projected UI. The projected UI may include at least one or more items. Here, the electronic apparatus 100 may perform spatial analysis to identify whether the predetermined event is at the position of the projected UI. The electronic apparatus 100 may perform spatial analysis through a sensor (e.g., an image sensor, an infrared sensor, a depth camera, a distance sensor, etc.) The electronic apparatus 100 may identify whether the predetermined event occurs at a specific position (a position on which the UI is projected) by performing spatial analysis. Based on the predetermined event being identified as occurring at the specific position (the position on which the UI is projected), the electronic apparatus 100 may identify that a user input for selecting a UI corresponding to the specific position has been received.

For example, the operation interface 115 may receive a user command for operating a multi-projection function. In an embodiment, a touch/jog icon for inputting the user command may be provided through a display. In addition, based on the touch/jog icon being selected through a touch display from the operation interface 115, the electronic apparatus 100 may receive a user command (e.g., the user command to operate the multi-projection function).

The input/output interface 116 may include various circuitry configured to input/output at least one of an audio signal or an image signal. The input/output interface 116 may receive at least one of the audio signal or the image signal from an external device, and may output a control command to the external device.

According to an implementation example, the input/output interface 116 may be implemented as an interface for inputting/outputting only an audio signal and an interface for inputting only an image signal, or may be implemented as one interface for inputting both an audio signal and an image signal.

The input/output interface 116 according to various embodiments of the present disclosure may be implemented as at least one or more wired input/output interfaces of a high definition multimedia interface (HDMI), a mobile high-definition link (MHL), a universal serial bus (USB), USB C-type, a display port (DP), a thunderbolt, a video graphics array (VGA) port, a red-green-blue (RGB) port, a D-subminiature (D-SUB) or a digital visual interface (DVI). According to various embodiments, the wired input/output interface may be implemented as an interface for inputting only an audio signal and an interface for inputting only an image signal, or may be implemented as one interface for inputting both an audio signal and an image signal.

The electronic apparatus 100 may receive data through the wired input/output interface, but this is merely an example, and the electronic apparatus 100 may receive power through the wired input/output interface. For example, the electronic apparatus 100 may receive power from an external battery through the USB C-type or may receive power from an outlet through a power adapter. As another example, the electronic apparatus 100 may receive power from an external device (e.g., a notebook computer or a monitor) through the DP.

The audio signal may be implemented to be input through the wired input/output interface, and the image signal may be input through a wireless input/output interface (or a communication interface). The audio signal may be input through the wireless input/output interface (or a communication interface), and the image signal may be implemented to be input through the wired input/output interface.

The speaker 117 is a component to output an audio signal. In particular, the speaker 117 may include an audio output mixer, an audio signal processor, and a sound output module. The audio output mixer may synthesize a plurality of audio signals to be output into at least one audio signal. For example, the audio output mixer may synthesize an analog audio signal and another analog audio signal (e.g., an analog audio signal received from the outside) into at least one analog audio signal. The sound output module may include a speaker or an output terminal. According to various embodiments, the sound output module may include a plurality of speakers, and in this case, the sound output module may be disposed inside the main body, and sound emitted by covering at least a part of a diaphragm of the sound output module may pass through a waveguide and be transmitted to the outside of the main body. The sound output module includes a plurality of sound output units, and the plurality of sound output units are symmetrically disposed on the exterior of the main body to emit sound in all directions, that is, in all directions of 360 degrees.

The microphone 118 is a component to receive user voice or other sound and converting the user voice or other sound into audio data. The microphone 118 may receive user voice in an active state. For example, the microphone 118 may be integrally formed in an upper side, a front direction, a side direction, etc. of the electronic apparatus 100. The microphone 118 may include various components such as a microphone that collects analog user voice, an amplifier circuit that amplifies the collected user voice, an A/D conversion circuit that samples the amplified user voice and converts the user voice into a digital signal, a filter circuit that removes a noise component from the converted digital signal, etc.

The power supply 119 may receive power from the outside and supply power to various components of the electronic apparatus 100. The power supply 119 according to various embodiments of the present disclosure may receive power through various methods. In various embodiments, the power supply 119 may receive power using a connector. In addition, the power supply 119 may receive power using a DC power cord of 220V. However, the present disclosure is not limited thereto, and the electronic apparatus 100 may receive power using a USB power cord or may receive power using a wireless charging method.

The power supply 119 may receive power using an internal battery or an external battery. The power supply 119 according to various embodiments of the present disclosure may receive power through the internal battery. For example, the power supply 119 may charge the power of the internal battery using at least one of a DC power cord, a USB power cord, or a USB C-Type power cord, and receive power through the charged internal battery. In addition, the power supply 119 according to various embodiments of the present disclosure may receive power through the external battery. For example, when the electronic apparatus 100 and the external battery are connected to each other through various wired communication methods such as a USB power cord, a USB C-Type power cord, a socket groove, etc., the power supply 119 may receive power through the external battery. That is, the power supply 119 may receive power directly from the external battery, or charge the internal battery through the external battery and receive power from the charged internal battery.

The power supply 119 according to the present disclosure may receive power using at least one or more of the plurality of power supply methods described above.

In relation to power consumption, the electronic apparatus 100 may have power consumption less than or equal to a preset value (e.g., 43 W) due to a socket shape and other standards. In this regard, the electronic apparatus 100 may vary the power consumption so as to reduce power consumption during use of a battery. That is, the electronic apparatus 100 may vary the power consumption based on a power supply method and a power consumption amount.

The driver 120 may include various circuitry and drive at least one hardware component included in the electronic apparatus 100. The driver 120 may generate a physical force and transmit the physical force to the at least one hardware component included in the electronic apparatus 100. Here, the driver 120 may generate driving power to move (e.g., move the electronic apparatus 100) hardware components included in the electronic apparatus 100.

For example, the driver 120 may move a position of the electronic apparatus 100. Here, the driver 120 may control a moving member 109 to move the electronic apparatus 100. For example, the driver 120 may control the moving member 109 using a motor and a wheel. The driver 120 according to the present disclosure may be referred to as various terms such as a traveler, an operator, a mover, etc.

The sensor 121 may include at least one sensor. For example, the sensor 121 may include at least one of an inclination sensor that senses inclination of the electronic apparatus 100 and an image sensor that captures an image. Here, the inclination sensor may be an acceleration sensor or a gyro sensor, and the image sensor may refer, for example, to a camera or a depth camera. The inclination sensor may be referred to as a motion sensor. In addition, the sensor 121 may include various sensors in addition to the inclination sensor or the image sensor. For example, the sensor 121 may include an illuminance sensor and a distance sensor. The distance sensor may be a time of flight (ToF). In addition, the sensor 121 may include a LiDAR sensor.

For example, the sensor 121 may obtain a sensing value for obtaining information about whether the external device 200 is located within a sensing range using at least one sensor. In addition, the sensor 121 may obtain obstacle information within a sensing range using at least one sensor.

The electronic apparatus 100 may control a lighting function in conjunction with an external device. For example, the electronic apparatus 100 may receive lighting information from the external device. The lighting information may include at least one of brightness information or color temperature information set in the external device. The external device may refer to a device connected to the same network as the electronic apparatus 100 (e.g., IoT device included in the same home/company network) or a device that is not the same network as the electronic apparatus 100 but may be communicable with the electronic apparatus 100 (e.g., a remote control server). For example, it is assumed that an external lighting device (IoT device) included in the same network as the electronic apparatus 100 outputs red lighting with a brightness of 50. The external lighting device (IoT device) may directly or indirectly transmit lighting information (e.g., information indicating that red lighting is being output at the brightness of 50) to the electronic apparatus 100. The electronic apparatus 100 may control an output of the light source based on the lighting information received from the external lighting device. For example, when the lighting information received from the external lighting device includes the information indicating that the red lighting is output at the brightness of 50, the electronic apparatus 100 may output the red lighting at the brightness of 50.

The electronic apparatus 100 may control the lighting function based on biometric information. For example, the processor 111 may obtain biometric information of the user. The biometric information may include at least one of a body temperature, a heart rate, a blood pressure, a respiration, or electrocardiogram of the user. Here, the biometric information may include various information other than the above-described information. For example, the electronic apparatus 100 may include a sensor for measuring the biometric information. The processor 111 may obtain the biometric information of the user through a sensor and control the output of the light source based on the obtained biometric information. As another example, the processor 111 may receive the biometric information from an external device through the input/output interface 116. Here, the external device may refer to a portable communication device (e.g., a smartphone or a wearable device) of the user. The processor 111 may obtain the biometric information of the user from the external device, and control the output of the light source based on the obtained biometric information. Meanwhile, according to an implementation example, the electronic apparatus 100 may identify whether the user is sleeping, and when the user is identified as sleeping (or preparing to sleep), the processor 111 may control the output of the light source based on the biometric information of the user.

The electronic apparatus 100 according to various embodiments of the present disclosure may provide various smart functions.

For example, the electronic apparatus 100 may be connected to a portable terminal device for controlling the electronic apparatus 100 so that a screen that is output from the electronic apparatus 100 may be controlled through a user input that is input from the portable terminal device. For example, the portable terminal device may be implemented as a smartphone including a touch display, and the electronic apparatus 100 may receive and output screen data provided by the portable terminal device from the portable terminal device, and the screen output from the electronic apparatus 100 may be controlled according to the user input that is input from the portable terminal device.

The electronic apparatus 100 may share content or music provided by the portable terminal device by connecting to the portable terminal device through various communication methods such as Miracast, Airplay, wireless DEX, a remote PC method, etc.

The portable terminal device and the electronic apparatus 100 may be connected to each other in various connection methods. In various embodiments, the portable terminal device may search for the electronic apparatus 100 to perform a wireless connection, or the electronic apparatus 100 may search for the portable terminal device to perform a wireless connection. In addition, the electronic apparatus 100 may output content provided by the portable terminal device.

In various embodiments, while specific content or music is being output from the portable terminal device, when a preset gesture is detected through a display of the portable terminal device (e.g., a motion tab view) after placing the portable terminal device near the electronic apparatus 100, the electronic apparatus 100 may output the content or the music being output from the portable terminal device.

In various embodiments, while specific content or music is being output from the portable terminal device, when the portable terminal device approaches the electronic apparatus 100 below a preset distance (e.g., a non-contact tab view), or when the portable terminal device contacts the electronic apparatus 100 twice at short intervals (e.g., a contact tab view), the electronic apparatus 100 may output the content or the music being output from the portable terminal device.

In the various example embodiments, it has been described that the same screen as the screen provided by the portable terminal device is provided from the electronic apparatus 100, but the present disclosure is not limited thereto. For example, when a connection between the portable terminal device and the electronic apparatus 100 is established, the portable terminal device may output a first screen provided by the portable terminal device, and the electronic apparatus 100 may output a second screen that is different from the first screen and provided by the portable terminal device. For example, the first screen may be a screen provided by a first application installed in the portable terminal device, and the second screen may be a screen provided by a second application installed in the portable terminal device. For example, the first screen and the second screen may be different screens provided by one application installed in the portable terminal device. In addition, for example, the first screen may be a screen including a UI in the form of a remote controller for controlling the second screen.

The electronic apparatus 100 according to the present disclosure may output a standby screen. For example, when the electronic apparatus 100 is not connected to an external device or when there is no input received from the external device for a preset time, the electronic apparatus 100 may output the standby screen. The conditions for the electronic apparatus 100 to output the standby screen are not limited to the above-described example, and the standby screen may be output under various conditions.

The electronic apparatus 100 may output the standby screen in the form of a blue screen, but the present disclosure is not limited thereto. For example, the electronic apparatus 100 may obtain an atypical object by extracting only the shape of a specific object from data received from the external device, and output the standby screen including the obtained atypical object.

The electronic apparatus 100 may further include a display (not shown).

The display (not shown) may be implemented as a variety of types of display such as a liquid crystal display (LCD), an organic light emitting diodes (OLED) display, a plasma display panel (PDP), etc. The display (not shown) may also include a driving circuit, a backlight unit, etc. that may be implemented in the form of an amorphic silicon thin film transistor (a-si TFT), a low temperature polysilicon (LTPS) TFT, an organic TFT (OTFT), etc. Meanwhile, the display (not shown) may be implemented as a touch screen combined with a touch sensor, a flexible display, a three-dimensional (3D) display, etc. In addition, according to various embodiments of the present disclosure, the display (not shown) may include not only a display panel outputting an image but also a bezel housing the display panel. In particular, according to various embodiments of the present disclosure, the bezel may include a touch sensor (not shown) for detecting a user interaction.

The electronic apparatus 100 may further include a shutter unit (not shown).

The shutter unit (not shown) may include at least one of a shutter, a fixing member, a rail, or a body.

The shutter may block light output from the projector 112. Here, the fixing member may fix a position of the shutter. Here, the rail may be a path for moving the shutter and the fixing member. Here, the body may be a component including the shutter and the fixing member.

The processor 111 may be implemented as a digital signal processor (DSP) that processes a digital signal, a microprocessor, and a time controller (TCON). However, the processor 111 is not limited thereto, and may include one or more of a central processing unit (CPU), a micro controller unit (MCU), a micro processing unit (MPU), a controller, an application processor (AP), a graphics-processing unit (GPU), a communication processor (CP), or an advanced reduced instruction set computer (RISC) machine (ARM) processor, or may be defined by the corresponding terms. In addition, the processor 111 may be implemented as a system-on-chip (SoC) or a large scale integration (LSI), in which a processing algorithm is embedded, or may be implemented in the form of a field programmable gate array (FPGA).

In addition, the processor 111 may perform various functions by executing computer executable instructions stored in the memory 113. Thus, the processor 111 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For example, by executing at least one command stored in the memory 113, the processor 111 identifies a projection surface corresponding to an image projection based on an event corresponding to the image projection, and controls the driver 120 to move to an optimal projection position obtained based on a projection distance to the projection surface, a projection angle corresponding to the image projection to the projection surface, and a movement distance.

In various embodiments, the processor 111 may obtain scores corresponding to a plurality of candidate positions based on a projection distance, a projection angle, and a movement distance with respect to each of the plurality of candidate positions obtained with respect to the current position, and obtain the optimal projection position based on the obtained scores.

In various embodiments, based on a projection distance from the candidate position to the projection surface being within a first range, the processor 111 may obtain a first score which is the highest point as a score corresponding to the projection distance, and based on the projection distance from the candidate position to the projection surface being farther than the first range, obtain a score corresponding to the projection distance lower than the first score.

In various embodiments, based on a projection angle corresponding to a projection to the projection surface from the candidate position being less than a first value, the processor 111 may obtain a second score which is the highest point as a score corresponding to the projection angle, and based on the projection angle corresponding to the image projection to the projection surface from the candidate position being greater than the first value, obtain a score corresponding to a projection angle lower than the second score.

In various embodiments, based on a movement distance to the candidate position being less than a second value, the processor 111 may obtain a third score which is the highest point as a score corresponding to the movement distance, and based on the movement distance to the candidate position being greater than the second value, obtain a score with respect to the movement distance lower than the third score.

In various embodiments, based on an obstacle existing near the projection surface, the processor 111 may obtain a projection angle for projecting an image onto the projection surface by avoiding the obstacle based on the current projection angle, an angle of view, the size of the obstacle, and the projection distance to the projection surface.

In various embodiments, based on an obstacle existing near the projection surface, the processor 111 may obtain a movement distance for projecting an image from the front of the projection surface by avoiding the obstacle based on the current projection angle, the angle of view, the size of the obstacle, and the projection distance to the projection surface.

In various embodiments, the processor 111 may move to an optimal projection position and then identify whether an obstacle exists within a range for projecting an image onto the projection surface around the optimal projection position.

In various embodiments, based on no obstacle existing within the range, the processor 111 may control an image to be projected onto the projection surface at the optimal projection position, and based on an obstacle existing within the range, obtain one of the plurality of candidate positions around the optimal projection position based on the projection distance, the projection angle, and the movement distance.

In various embodiments, the processor 111 may move to the optimal projection position and then project an image through the projector 112.

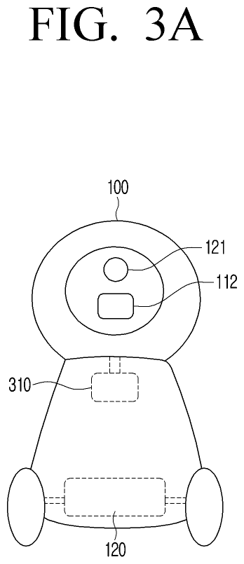

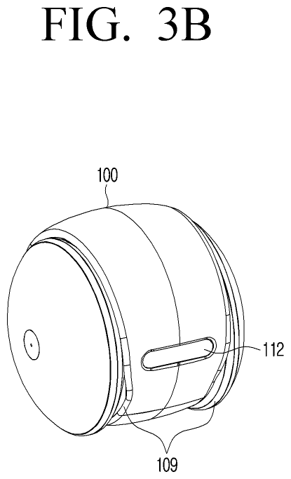

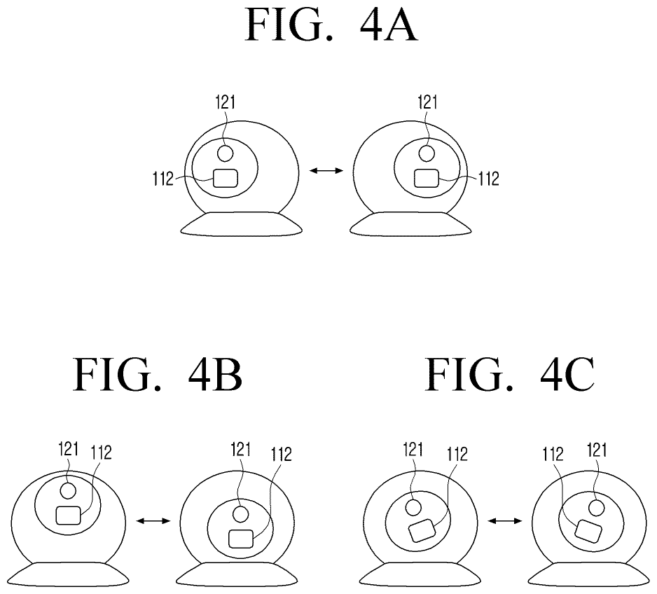

FIGS. 3A and 3B are perspective views illustrating an external appearance of the electronic apparatus 100 according to various embodiments. As shown in FIG. 3A, the electronic apparatus 100 may include the sensor 121 and the projector 112 in a head area. The head area may refer to an area located at an upper end of the electronic apparatus 100, and may be referred to as various terms such as an upper area, a top area, a detection area, a projection area, etc. In addition, the head area of the electronic apparatus 100 may be rotated to adjust a projection angle or to sense information about the surrounding of the electronic apparatus 100. In this regard, the head area of the electronic apparatus 100 may be rotated by the rotator 310 as shown in FIG. 3. In various embodiments, as shown in FIG. 4A, the head area of the electronic apparatus 100 may perform yaw rotation in the left and right directions. In addition, as shown in FIG. 4B, the head area of the electronic apparatus 100 may perform pitch rotation in the up and down direction. In addition, as shown in FIG. 4C, the head area of the electronic apparatus 100 may perform roll rotation in the clockwise/counterclockwise direction However, as shown in FIG. 4, the head area of the electronic apparatus 100 may rotate in all three-axis directions, but this is only an example and the head area of the electronic apparatus 100 may rotate in only some of the three-axis directions.

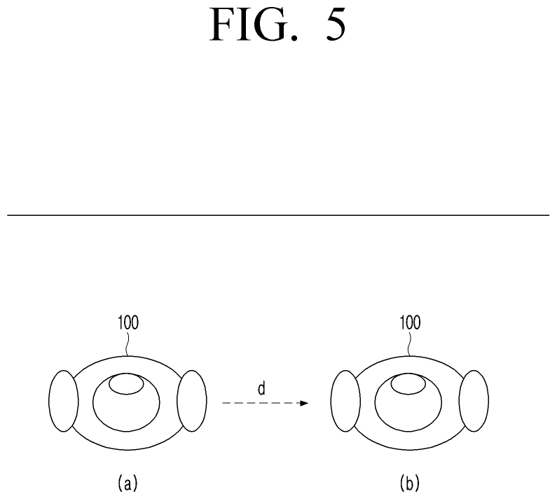

In addition, the driver 120 may be included in a lower area of the electronic apparatus 100. The driver 120 may move the electronic apparatus 100 by driving a moving member (e.g., a wheel). For example, as shown in FIG. 5, the electronic apparatus 100 may move by a distance d from point (a) to point (d) with respect to an image projection surface through the driver 120.

For example, the electronic apparatus 100 may adjust a projection angle of the electronic apparatus 100 through the rotator 310, and may adjust a projection position of the electronic apparatus 100 through the driver 120.

FIG. 3B is a diagram illustrating an external appearance of an electronic device according to an embodiment of the present disclosure. Referring to an embodiment of FIG. 3, the electronic apparatus 100 may include the moving member 109. The moving member 109 may refer, for example, to a member for moving the electronic apparatus 100 from a first position to a second position in a space in which the electronic apparatus 100 is disposed. The electronic apparatus 100 may control the moving member 109 so that the electronic apparatus 100 moves using the force generated by the driver 120. In this case, the moving member 109 may include a motor or a wheel. In addition, the electronic apparatus 100 may include the projector 112 on one area of the main body, as shown in FIG. 3B.

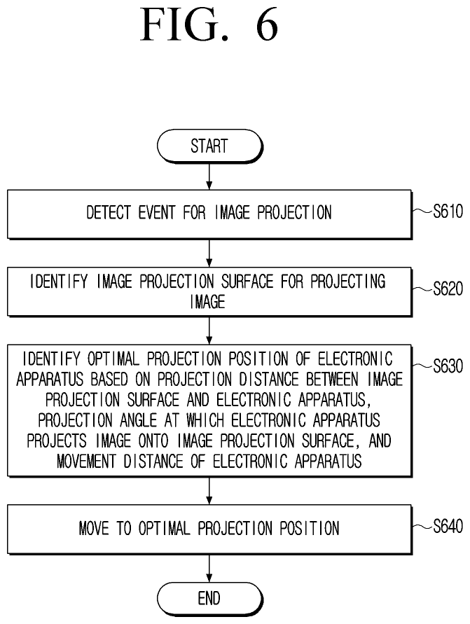

FIG. 6 is a flowchart illustrating example operations in which an electronic apparatus projects an image by identifying an optimal projection position according to various embodiments.

The electronic apparatus 100 detects an event for image projection (S610). The event for image projection may be an event in which a user inputs an image projection command, but the event for image projection is not limited thereto, and may be various events such as an event reaching a preset time or an event in which the user approaches the surroundings of the electronic apparatus 100.

The electronic apparatus 100 may identify an image projection surface for projecting the image (S620). The image projection surface is an area for the electronic apparatus 100 to project the image, and may be, for example, a wall, but this is only an embodiment, and the image projection surface may be a floor or a screen of a preset color (e.g., white).

For example, the electronic apparatus 100 may obtain a position of the electronic apparatus 100 and information about surrounding obstacles by scanning the surroundings of the electronic apparatus 100 using the sensor 121. The electronic apparatus 100 may identify the image projection surface for projecting the image based on the position of the electronic apparatus 100, the information about surrounding obstacles, and pre-stored map data. In various embodiments, the electronic apparatus 100 may identify a wall surface closest to the position where the electronic apparatus 100 is located as the image projection surface. In various embodiments, the electronic apparatus 100 may identify a wall surface on which no obstacle exists at the position where the electronic apparatus 100 is located as the image projection surface. In various embodiments, the electronic apparatus 100 may identify a screen located closest to the electronic apparatus 100 as the image projection surface. This is merely an example, and the image projection surface may be identified in various ways.

The electronic apparatus 100 may identify an optimal projection position of the electronic apparatus 100 based on a projection distance between the image projection surface and the electronic apparatus 100, a projection angle at which the electronic apparatus 100 projects the image onto the image projection surface, and a movement distance of the electronic apparatus 100 (S630).

For example, the electronic apparatus 100 may identify a plurality of candidate positions with respect to the current position of the electronic apparatus 100. In various embodiments, the electronic apparatus 100 may identify the plurality of candidate positions located in the surroundings of the electronic apparatus 100 based on the map data.

The electronic apparatus 100 may identify scores with respect to the plurality of candidate positions based on a projection distance, a projection angle, and a movement distance with respect to each of the identified plurality of candidate positions.

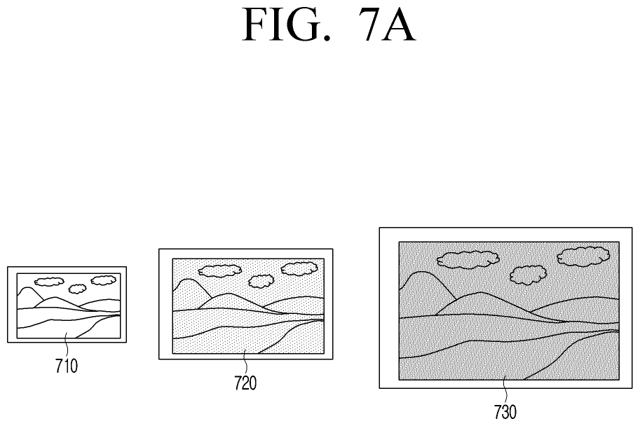

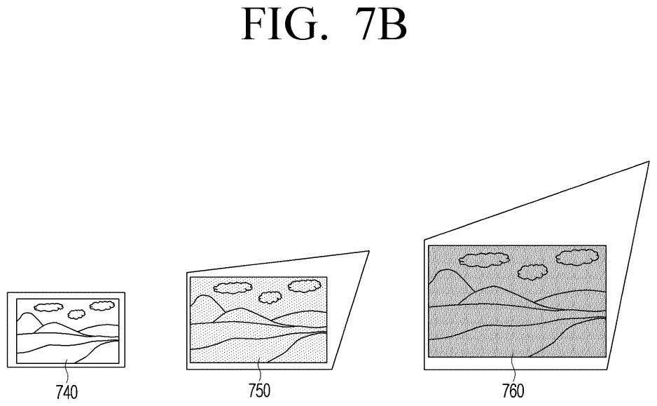

For example, the size, brightness, and resolution of a projected screen vary depending on the projection distance and the projection angle, and the time and stability required to project the image vary depending on the movement distance. That is, to identify the optimal projection position, the projection distance, the projection angle, and the movement distance are very important factors. For example, a first factor for identifying the optimal projection position is the projection distance. The projection distance refers to a distance between the electronic apparatus 100 and the image projection surface, and is a factor that determines the size and brightness of the projected screen. For example, as shown in FIG. 7A, a first screen 710 with the shortest projection distance may have a small screen size but a high image brightness, whereas a second screen 720 with an intermediate projection distance may have a larger screen size than the first screen 710 but a darker image brightness than the first screen 710. A third screen 730 with the farthest projection distance may have a larger screen size than the first screen 710 and the second screen 720, but a darker image brightness than the first screen 710 and the second screen 720. For example, based on the projection distance having an appropriate value that is neither too close nor too far, the electronic apparatus 100 may provide the optimal image quality in terms of the size and brightness of the image.

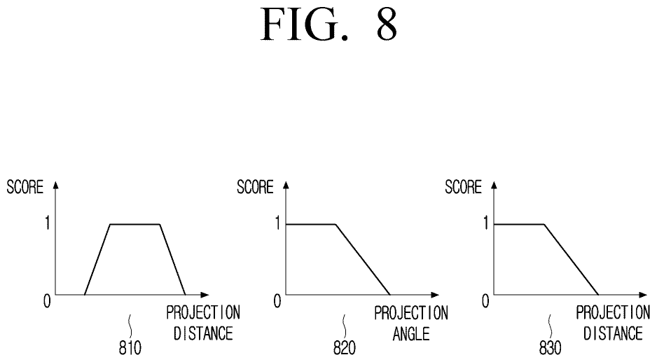

In an embodiment of the present disclosure, based on the projection distance from the candidate position with respect to each of the plurality of candidate positions to the image projection surface being within a first range, the electronic apparatus 100 may identify a first score with respect to the projection distance as the highest point, and identify the first score with respect to the projection distance to be lower than the highest point as the projection distance from the candidate position to the image projection surface is farther than the first range. For example, as in a first graph 810 of FIG. 8, based on the projection distance being within the first range, the first score with respect to the projection distance is 1 which is the highest point, but as the projection distance is farther than the first range, the first score may be lower. The first range may be set differently according to a projection mode of the electronic apparatus 100, the type of a projection lens, and the type of content. Alternatively, the first range may be set by the user.

A second factor for identifying the optimal projection position is the projection angle. The projection angle refers to an angle at which the electronic apparatus 100 is rotated toward the projection surface with respect to the projection surface, and the resolution and brightness of the projection screen may be determined according to the projection angle. As shown in FIG. 7B, the projection range of a first screen 740 with a projection angle of 0 has the same rectangular shape as the screen, but as the projection angle increases, the projection ranges of a second screen 750 and a third screen 760 asymmetrically increase in the up and down and left and right. In this case, the electronic apparatus 100 may perform keystone correction so that the projection screen appears straight again. However, as in the second screen 750 and the second screen 560, a ratio of the size of the screen to the projection range is reduced due to keystone correction. That is, because the number of pixels of the screen decreases, the resolution decreases and the brightness is darker. Therefore, as the projection angle is smaller, the optimal image quality may be provided in terms of resolution and brightness.

In an embodiment of the present disclosure, based on the projection angle with respect to the image projection surface from the candidate position with respect to each of the plurality of candidate positions being less than a first value, the electronic apparatus 100 may identify a second score with respect to the projection angle as the highest point, and identify the second score with respect to the projection angle to be lower than the highest point as the projection angle with respect to the image projection surface from the candidate position is greater than the first value. For example, as in a second graph 820 of FIG. 8, based on the projection angle being less than the first value, the second score with respect to the projection angle is 1 which is the highest point, but the greater the projection angle is than the first value, the lower the second score may be. The first value is a value close to 0 and may be preset, but this is only an embodiment and the first value may be set by the user.

A third factor for identifying the optimal projection position is the movement distance. The movement distance refers to a distance for the electronic apparatus 100 to move from the current position to the projection position, and may determine the time required and stability of the electronic apparatus 100. Specifically, as the movement distance increases, because the electronic apparatus 100 needs to move far, the time required increases accordingly, and the risk of occurrence of an unexpected event increases. Therefore, a projection position closer to the current position may be a better projection position. When the electronic apparatus 100 uses wired power, the movement distance may be limited according to the length of a power cable. The first value may be 0.

In an embodiment of the present disclosure, based on the movement distance to the candidate position with respect to each of the plurality of candidate positions being less than a second value, the electronic apparatus 100 may identify a third score with respect to the movement distance as the highest point, and identify the third score with respect to the movement distance to be lower than the highest point as the movement distance is farther than the second value. For example, as in a third graph 830, based on the movement distance being less than the second value, the third score with respect to the movement distance is 1 which is the highest point, but as the movement distance is farther than the second value, the third score may be lower. The second value may be preset, but this is only an embodiment and the second value may be set by the user. The second value may be 0.

Referring to FIG. 8, the highest point is described as 1, but this is merely an example and the highest point may be implemented as other values.

In addition, the electronic apparatus 100 may calculate final scores by adding the first to third scores with respect to the plurality of candidate positions, and identify the candidate position with the largest score among the calculated final scores as the optimal projection position.

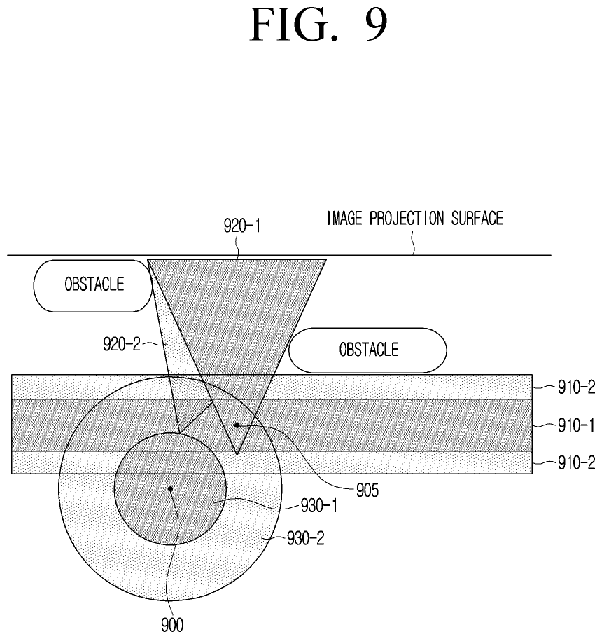

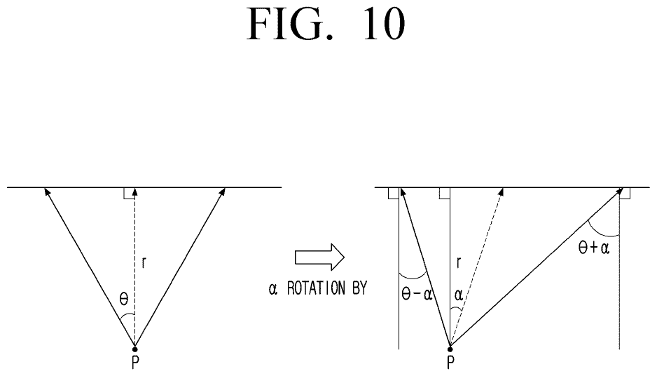

FIG. 9 is a diagram illustrating an example method of identifying an optimal projection position according to a projection distance, a projection angle, and a movement distance according to various embodiments.

As shown in FIG. 9, the electronic apparatus 100 scans the surroundings at a current position 900 with the sensor 121 to recognize positions and distances of two obstacles and an image projection surface. In addition, the electronic apparatus 100 calculates first to third scores for each criterion described above with respect to a plurality of candidate positions in a surrounding space.

Referring to FIG. 9, the first score according to the projection distance is indicated as a square, the second score according to the projection angle is indicated as a triangle, and the third score according to the movement distance is indicated as a circle. That is, when the electronic apparatus 100 is located in a first area 910-1 of the rectangle, the first score may be the highest point, and when the electronic apparatus 100 is located in a second area 910-2 of the rectangle, the first score may be a lower score than the highest point. In addition, when the electronic apparatus 100 is located in a first area 920-1 of the triangle, the second score may be the highest point, and when the electronic apparatus 100 is located in a second area 920-2 of the triangle, the second score may be a lower score than the highest point. When the electronic apparatus 100 is located in a first area 930-1 of the circle, the third score may be the highest point, and when the electronic apparatus 100 is located in a second area 930-2 of the circle, the third score may be a score lower than the highest point. A candidate position located in an area where areas with the high first to third scores overlap among the plurality of candidate positions may be identified as the optimal projection position. For example, the electronic apparatus 100 may identify a first point 905 as the optimal projection position.

The electronic apparatus 100 may move to the optimal projection position (S640). The electronic apparatus 100 may project an image at a projection angle identified at the optimal projection position. Based on the projection angle being greater than a threshold value, the electronic apparatus 100 may project the image by performing keystone correction.

On the other hand, based on projecting the image in front of the image projection surface, the electronic apparatus 100 may provide the best projection screen, but based on there being an obstacle in the front, needs to project the image by avoiding the obstacle. According to an embodiment of the present disclosure, the electronic apparatus 100 recognizes an obstacle around the image projection surface or an obstacle located at the projection position of the electronic apparatus 100 using the sensor 121 and calculates a projection angle capable of projecting an image in consideration of the recognized obstacle.

A projection distance r and a projection angle α will be described with reference to FIG. 10. As shown on the left side of FIG. 10, based on the projection angle being 0, the electronic apparatus 100 may project an image symmetrically left and right around a central axis. A dotted arrow indicates the central axis and solid arrows indicate both ends of the screen. At this time, the shortest distance between the electronic apparatus 100 projecting the image and the image projection surface is referred to as the projection distance r, and an angle at which the screen spreads from the center to the left and right is referred to as an angle of view è. The projection distance r may be different according to the environment, but the angle of view è has one fixed value as physical characteristics of the electronic apparatus 100. The drawing on the right side of FIG. 10 shows that the electronic apparatus 100 rotates to the right by an angle α with respect to the image projection surface so that the projection angle becomes α. An angle between the left end of the projection screen and the projection surface is θ−α, and an angle between the right end of the projection screen and the projection surface is θ+α.

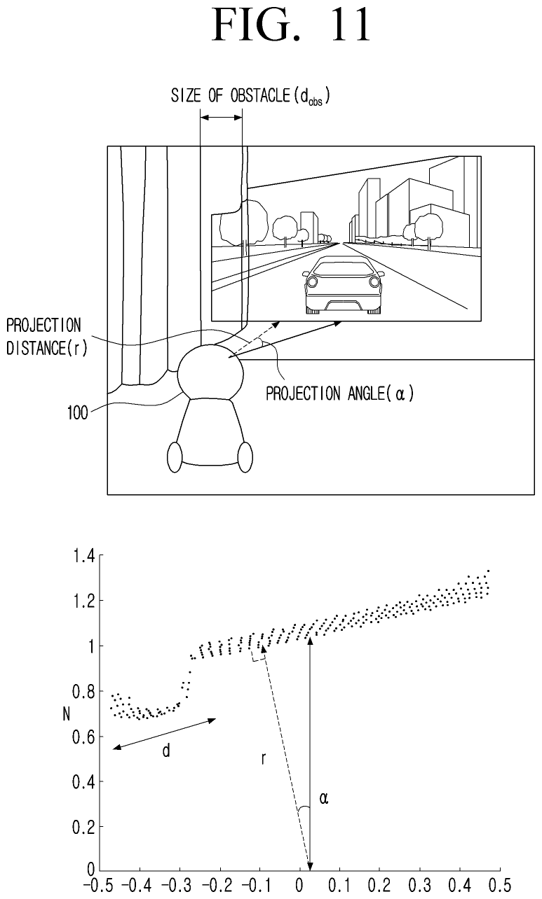

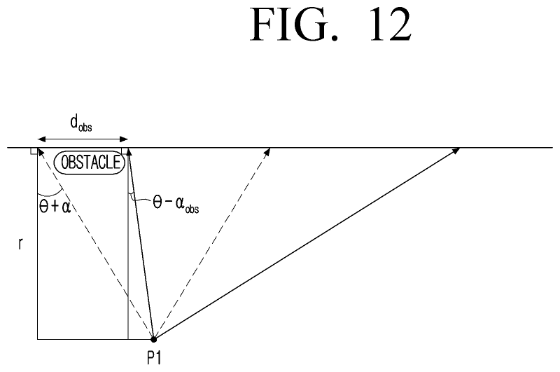

According to an embodiment of the present disclosure, the electronic apparatus 100 may calculate the projection distance r, a size d of the obstacle, and a current projection angle al based on sensing data obtained from a ToF sensor among the sensors 121. As shown in the upper end of FIG. 11, based on the image being projected, the sensing data obtained from the ToF sensor may be as shown in the lower end of FIG. 11. For example, a total of 443 data were detected, and each sensing data may express a point on the image projection surface in 3D position coordinates. The drawing shown in the upper end of FIG. 11 may represent the sensing data when viewed from above. The electronic apparatus 100 may obtain information about a thickness (d_{obs}) of an obstacle from a difference in position coordinates of the sensing data. The projection distance r and the projection angle α may be calculated by modeling a plane from the sensing data obtained from the ToF sensor. For example, the electronic apparatus 100 may measure the projection angle α by obtaining a normal vector of the plane from the sensing data and measuring an angle of the normal vector, and may measure the projection distance r from a distance between the plane and the electronic apparatus 100.

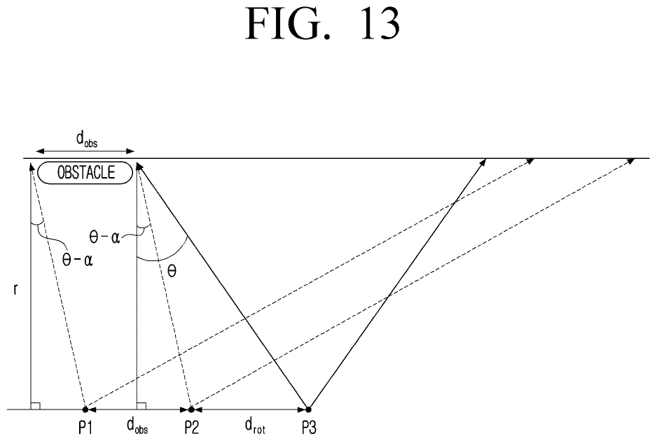

When identifying the optimal projection position among the plurality of candidate positions or projecting an image on the optimal projection position, in case where an obstacle exists near the image projection surface, the electronic apparatus 100 needs to project the image based on a new projection angle or project the image at a new projection position. This will be described in greater detail below with reference to FIGS. 12, 13 and 14.

According to various embodiments, based on the obstacle existing near the image projection surface, the electronic apparatus 100 may identify the new projection angle for projecting the image onto the image projection surface by avoiding the obstacle based on a current projection angle of the electronic apparatus 100, an angle of view of the electronic apparatus 100, the size of the obstacle, and a projection distance to the image projection surface.

This will be described with reference to FIG. 12. For example, in FIG. 12, a dotted arrow shows projecting an image at the current projection angle α, and a solid arrow shows projecting an image at a new projection angle αobs. The new projection angle αobs may be calculated from the current projection angle α, the angle of view θ, the size (d_{obs}) of the obstacle, and the projection distance r, as shown in Equation 1 below.

$${α}_{obs} = θ - a tan ( tan ( θ - α ) - {d}_{obs} / r ) \qquad [ Equation 1 ]$$

As described above, the current projection angle α, the size (d_{obs}) of the obstacle, and the projection distance r may be calculated from the ToF sensor, and the angle of view θ is a fixed value. According to Equation 1, the electronic apparatus 100 may calculate the new projection angle αobs, and automatically avoid the obstacle and project a screen by rotating by αobs−α.

Based on the obstacle being small, the obstacle may be sufficiently avoided only by a small rotation, but based on the obstacle being large, a too much rotation angle may be required to avoid the obstacle only by a rotation. In this case, because the score loss due to a rotation may be greater than the movement of the electronic apparatus 100, according to various embodiments of the present disclosure, the electronic apparatus 100 may avoid the obstacle by moving rather than rotating.

According to various embodiments, based on an obstacle existing near the image projection surface, the electronic apparatus 100 may identify a movement distance of the electronic apparatus 100 for projecting an image in the front of the image projection surface by avoiding the obstacle based on the current projection angle of the electronic apparatus 100, the angle of view of the electronic apparatus 100, the size of the obstacle, and the projection distance to the image projection surface.

This will be described with reference to FIG. 13. For example, FIG. 13 illustrates a process of calculating a movement distance for avoiding an obstacle according to various embodiments of the present disclosure. When the electronic apparatus 100 is capable of moving in parallel with the image projection surface as shown in FIG. 13, because a first score according to the projection distance is maintained, the optimal projection position may be determined only with respect to the projection angle and the movement distance. When the projection angle is fixed, the electronic apparatus 100 needs to move to a target position P2 away by d_{obs} from a current position P1 to avoid an obstacle having the size (d_{obs}).

For example, for front projection, the electronic apparatus 100 rotates by −α, but in this case, the position of the screen moves toward the obstacle. Therefore, when there is an obstacle, the electronic apparatus 100 needs to move additionally by drot from P2 to P3 while rotating by −α. The additional movement distance drot may be calculated from the projection distance r and the current projection angle α, as shown in Equation 2 below.

$${d}_{rot} = r ( tan ( θ ) - tan ( θ - α ) ) \qquad [ Equation 2 ]$$

The electronic apparatus 100 may calculate a final movement distance by adding the size (d_{obs}) of the obstacle to the calculated distance drot as described above. Accordingly, the electronic apparatus 100 may project the image in the front while simultaneously avoiding the obstacle by rotating by −α while moving by dobs+drat.

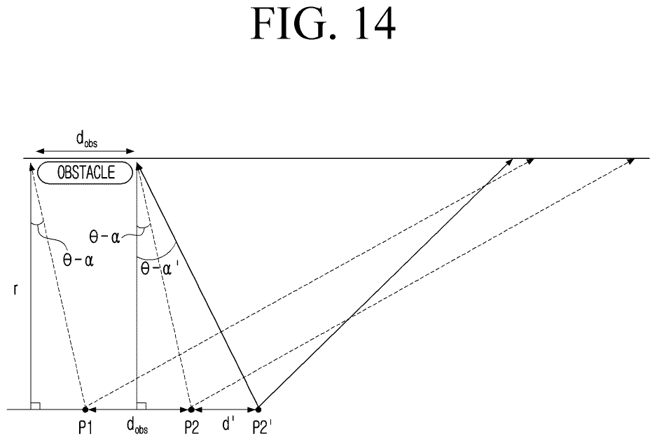

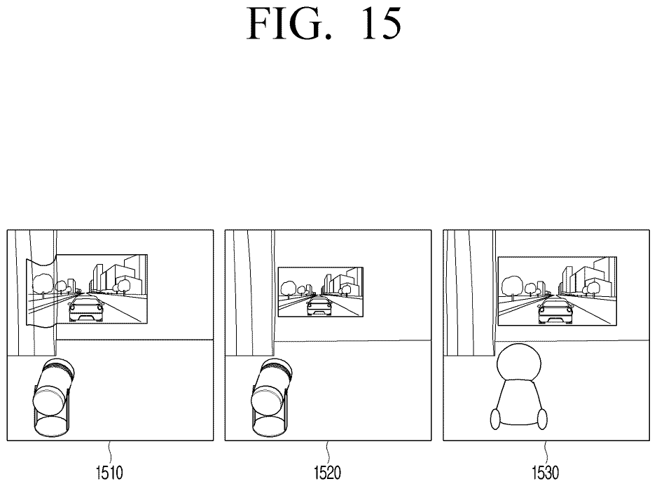

The electronic apparatus 100 may not sufficiently move due to space constraints. Such a situation will be described with reference to FIG. 14. For example, FIG. 14 is a diagram illustrating an operation when it is impossible for the electronic apparatus 100 to sufficiently move due to space constraints or a loss due to the movement is greater than a gain obtained by front projection. For example, an additional movement distance may be d′ less than drot, and the projection angle after rotation may be a′ greater than 0. When the additional movement distance is determined as d′, a process of calculating a′ may be calculated by Equation 3 below.

$${α}^{′} = θ - a tan ( tan ( θ - α ) + {d}^{′} / r ) \qquad [ Equation 3 ]$$

When the projection angle is determined as a′, a process of calculating d′ may also be calculated by Equation 3 above.

Therefore, the rotation angle and the movement distance of the electronic apparatus 100 may be as shown in Equation 4 below.

$$= {α}^{′} - α \qquad [ Equation 4 ]$$

$$= {d}_{obs} + {d}^{′}$$

According to various embodiments of the present disclosure as described above, the electronic apparatus 100 may project the image with the optimal size and image quality while avoiding the obstacle. FIG. 15 is a diagram illustrating image projection results according to conventional methods and an embodiment of the present disclosure

FIG. 15 is a diagram illustrating example images projected by the electronic apparatus 100 onto an image projection surface with an obstacle (e.g., a curtain) in the conventional methods and in a method according to various embodiments.

When the image is projected in a first conventional method, as shown in a first drawing 1510 of FIG. 15, the image is projected onto the image projection surface and the obstacle, which interfered with the user's viewing. In the case of a second conventional method of rotating only a projection angle to project the image by avoiding the obstacle, as shown in a second drawing 1520 of FIG. 15, there was a limitation in that the size of a screen is reduced or the resolution is low by keystone correction. However, a projection angle and a movement distance are simultaneously adjusted to avoid the obstacle, thereby providing an optimal projection screen, as in a third drawing 1530 of FIG. 15.

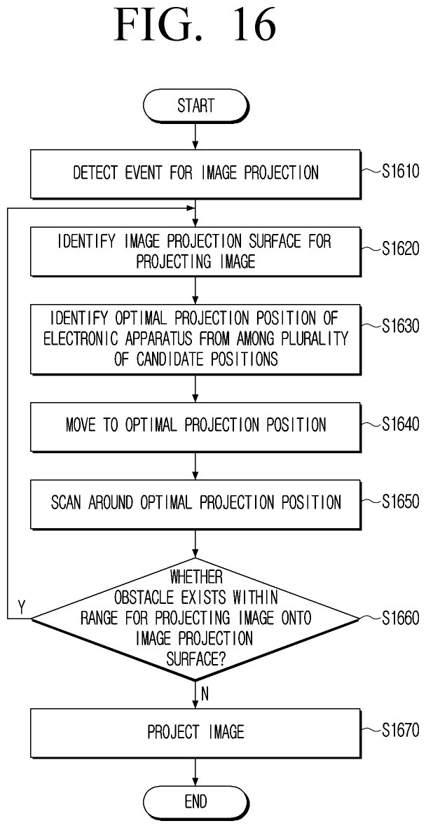

FIG. 16 is a flowchart illustrating example operations in which an image is projected by identifying an optimal projection position according to various embodiments.

The electronic apparatus 100 may detect an event for projecting the image (S1610). The event for image projection may be an event in which a user inputs an image projection command, but is not limited thereto, and the event for image projection may be various events.

The electronic apparatus 100 may identify an image projection surface for projecting the image (S1620). For example, the electronic apparatus 100 may scan the surroundings of the electronic apparatus 100 through the sensor 121 to identify the position of the electronic apparatus 100 and information about an obstacle, and identify the image projection surface based on the position of the electronic apparatus 100, the information about the obstacle, and map data.

The electronic apparatus 100 may identify the optimal projection position of the electronic apparatus 100 from among a plurality of candidate positions (S1630). For example, the electronic apparatus 100 may identify the optimal projection position of the electronic apparatus 100 based on a projection distance between an image projection surface and the electronic apparatus 100, a projection angle at which the electronic apparatus 100 projects the image onto the image projection surface, and a movement distance of the electronic apparatus 100.

The electronic apparatus 100 may move to the optimal projection position (S1640). For example, the electronic apparatus 100 may identify a driving path based on the map data and the optimal projection position, and may move to the optimal projection position according to the identified driving path.

The electronic apparatus 100 may scan around the optimal projection position (S1650). For example, the electronic apparatus 100 may identify information about an obstacle around the optimal projection position by scanning around the optimal projection position through the sensor 121. The detected obstacle may be an obstacle not detected by the sensor 121 at a previous position or a moving obstacle (e.g., a person, a pet, a robot cleaner, etc.), but is not limited thereto.

The electronic apparatus 100 may identify whether an obstacle exists within a range for projecting the image onto the image projection surface (S1660). For example, the electronic apparatus 100 may identify whether the obstacle exists within the image projection range or within a movement path for projecting the image.

When it is identified that no obstacle exists within the range for projecting the image onto the image projection surface, the electronic apparatus 100 may project the image onto the image projection surface at the optimal projection position (S1670).

However, when it is identified that the obstacle exists within the range for projecting the image onto the image projection surface, the electronic apparatus 100 may perform operation S1620 again. For example, the electronic apparatus 100 may re-search one of a plurality of candidate positions around the optimal projection position based on the projection distance, the projection angle, and the movement distance on the optimal projection position.

Meanwhile, the method according to various embodiments of the present disclosure may be included and provided in a computer program product. The computer program product may be traded as a product between a seller and a purchaser. The computer program product may be distributed in a form of the machine-readable storage medium (e.g., a compact disc read only memory (CD-ROM)), or may be distributed through an application store (e.g., PlayStore™) or directly or online (e.g., download or upload) between two user devices (e.g., smartphones). Based on the online distribution, at least some of the computer program product (e.g. downloadable app) may be at least temporarily stored or temporarily provided in a machine-readable storage medium such as memory of a server of a manufacturer, a server of an application store or a relay server.

A method according to various embodiments of the present disclosure may be implemented as software including instructions stored in a machine-readable storage medium readable by a device (e.g., a computer). The machine is a device capable of calling a stored instruction from a storage medium and operating according to the called instruction, and may include an electronic apparatus (e.g., TV) according to disclosed embodiments.

The machine-readable storage medium may be provided in the form of a non-transitory storage medium. Here, the ‘non-transitory storage medium’ indicates that the storage medium is tangible without including a signal, and does not distinguish whether data are semi-permanently or temporarily stored in the storage medium. For example, the ‘non-transitory storage medium’ may include a buffer in which data is temporarily stored.

Based on the instruction being executed by the processor, the processor may perform a function corresponding to the instruction directly or using other components under the control of the processor. The instruction may include codes generated or executed by a compiler or an interpreter.

Although various example embodiments of the present disclosure are shown and described hereinabove, the present disclosure is not limited to the above-mentioned example embodiments, and may be variously modified by those skilled in the art to which the present disclosure pertains without departing from the scope and spirit of the present disclosure including in the accompanying claims. These modifications should also be understood to fall within the scope and spirit of the present disclosure. It will also be understood that any of the embodiment(s) described herein may be used in conjunction with any other embodiment(s) described herein.

What is claimed is:

1. An electronic apparatus comprising:
a sensor;
a driver comprising circuitry;
memory storing instructions; and
at least one processor, comprising processing circuitry;
wherein at least one processor, collectively or individually, is configured to execute the instructions and to cause the electronic apparatus to:
based on an event corresponding to an image projection, identify a projection surface corresponding to the image projection, and
control the driver to move to a projection position obtained based on a projection distance to the projection surface, a projection angle corresponding to the image projection to the projection surface, and a movement distance.

2. The electronic apparatus of claim 1, wherein at least one processor collectively or individually, is configured to cause the electronic apparatus to:
obtain a score corresponding to each of a plurality of candidate positions based on the projection distance, the projection angle, and the movement distance with respect to each of the plurality of candidate positions obtained based on a current position, and
obtain a projection position based on the obtained score.

3. The electronic apparatus of claim 2, wherein at least one processor collectively or individually, is configured to cause the electronic apparatus to:
based on a projection distance from a candidate position to the projection surface being within a first range, obtain a first score which is a highest point as a score corresponding to the projection distance, and
based on the projection distance from the candidate position to the projection surface being farther than the first range, obtain a score corresponding to the projection distance lower than the first score.

4. The electronic apparatus of claim 2, wherein at least one processor collectively or individually, is configured to cause the electronic apparatus to:
based on a projection angle corresponding to an image projection to the projection surface from a candidate position being less than a first value, obtain a second score which is a highest point as a score corresponding to the projection angle, and
based on the projection angle corresponding to the image projection to the projection surface from the candidate position being greater than the first value, obtain a score corresponding to the projection angle lower than the second score.

5. The electronic apparatus of claim 2, wherein at least one processor collectively or individually, is configured to cause the electronic apparatus to:
based on a movement distance to a candidate position being less than a second value, obtain a third score which is a highest point as a score corresponding to the movement distance, and
based on the movement distance to the candidate position being greater than the second value, obtain a score with respect to the movement distance lower than the third score.

6. The electronic apparatus of claim 1, wherein at least one processor collectively or individually, is configured to cause the electronic apparatus to:
based on an obstacle existing near the projection surface, obtain a projection angle for projecting the image onto the projection surface to avoid the obstacle based on a current projection angle, an angle of view, a size of the obstacle, and a projection distance to the projection surface.

7. The electronic apparatus of claim 1, wherein at least one processor collectively or individually, is configured to cause the electronic apparatus to:
based on an obstacle existing near the projection surface, obtain a movement distance for projecting the image in front of the projection surface to avoid the obstacle based on a current projection angle, the angle of view, a size of the obstacle, and a projection distance to the projection surface.

8. The electronic apparatus of claim 1, wherein at least one processor collectively or individually, is configured to cause the electronic apparatus to:
after moving to the projection position, identify whether an obstacle exists within a range for projecting an image onto the projection surface around the optimal projection position.

9. The electronic apparatus of claim 8, wherein at least one processor collectively or individually, is configured to cause the electronic apparatus to:
based on no obstacles existing within the range, control the image to be projected onto the projection surface at the projection position, and
based on the obstacle existing within the range, obtain one of a plurality of candidate positions around the projection position based on the projection distance, the projection angle, and the movement distance.

10. The electronic apparatus of claim 1, further comprising: a projector,
wherein at least one processor collectively or individually, is configured to cause the electronic apparatus to:
after moving to the projection position, project an image through the projector.

11. A method of controlling an electronic apparatus, the method comprising:
based on an event corresponding to an image projection, identifying a projection surface corresponding to the image projection; and
moving to a projection position obtained based on a projection distance to the projection surface, a projection angle corresponding to the image projection to the projection surface, and a movement distance.

12. The method of claim 11, wherein the moving includes:
obtaining a score corresponding to each of a plurality of candidate positions based on the projection distance, the projection angle, and the movement distance with respect to each of the plurality of candidate positions obtained based on a current position; and
obtaining a projection position based on the obtained score.

13. The method of claim 12, wherein the obtaining of the score includes:
based on a projection distance from a candidate position to the projection surface being within a first range, obtaining a first score which is a highest point as a score corresponding to the projection distance; and
based on the projection distance from the candidate position to the projection surface being farther than the first range, obtaining a score corresponding to the projection distance lower than the first score.

14. The method of claim 12, wherein the obtaining of the score includes:
based on a projection angle corresponding to an image projection to the projection surface from a candidate position being less than a first value, obtaining a second score which is a highest point as a score corresponding to the projection angle; and
based on the projection angle corresponding to the image projection to the projection surface from the candidate position being greater than the first value, obtaining a score corresponding to the projection angle lower than the second score.

15. The method of claim 12, wherein the obtaining of the score includes:
based on a movement distance to a candidate position being less than a second value, obtaining a third score which is a highest point as a score corresponding to the movement distance; and
based on the movement distance to the candidate position being greater than the second value, obtaining a score with respect to the movement distance lower than the third score.
